(19) United States
(12) Patent Application Publication
(10) Pub. No.: US 2007/0002918 A1
(43) Pub. Date: Jan. 4, 2007

(54) Acoustic shock-wave damping in pulsed gas-laser discharge

(76) Inventors: Norbert Niemoeller, Ebergoetzen (DE); Igor Bragin, Goettingen (DE); Vadim Berger, Goettingen (DE)

Correspondence Address: STALLMAN & POLLOCK LLP, 353 SACRAMENTO STREET, SUITE 2200, SAN FRANCISCO, CA, 94111, US

(21) Appl. No.: 11/172,266

(22) Filed: Jun. 30, 2005

(51) Int. Cl. H01S 3/22; H01S 3/097

(52) U.S. Cl. 372/55; 372/87

(57) ABSTRACT

An excimer laser has a laser chamber containing a laser gas and including an electrode assembly for firing gas discharge pulses in the laser gas for pumping the laser. The electrode assembly includes two elongated electrodes, one or both of which is partially covered by a ceramic foam. The electrodes are arranged to provide a discharge gap between the electrodes. The ceramic foam on an electrode serves to damp acoustic disturbances and resulting refractive index disturbances in the gas that occur as a result of firing a gas discharge pulse in the discharge gap.

### TECHNICAL FIELD OF THE INVENTION

The present invention relates in general to excimer lasers. The invention relates in particular to damping of acoustic shock waves generated during high-repetition frequency, pulsed operation of such lasers.

### DISCUSSION OF BACKGROUND ART

During operation of an excimer or molecular fluorine (F₂) laser, particularly when operating the laser at high pulse repetition frequency (PRF), for example, about 4 kilohertz (kHz), acoustic shock waves are generated at discharge electrodes of the laser. The acoustic shock waves propagate through the lasing (excimer or F₂) gas and reach walls of the laser chamber in which the electrodes are located and in which the lasing gas is confined. The acoustic shock waves are reflected back into a discharge area between the electrodes in which optical gain in the lasing gas is generated by the discharge.

The acoustic shock waves are unwanted pressure changes in the gas that, when reflected back into the discharge area, disturb the performance of the laser system. The degree to which the energy efficiency and energy stability of the laser system are affected depends upon the PRF, as this frequency can interact with natural acoustic modes of the chamber.

In order to stabilize the operation and the energy efficiency of the laser it is necessary to damp these disturbances acoustic shock waves. Several approaches to such damping are described in the prior-art. One approach is to use angled reflectors in the laser chamber to assist in dissipating the acoustic shock waves. These reflectors may have different configurations. By way of example, the angled reflectors may have grooves and holes defined in the reflective surface, which scatter acoustic shock waves incident thereon as well as generate interference within the waves. The angled reflectors may also be covered with an acoustic shock-wave absorbing material, such as felt metal. Further, angled reflectors may have layers thereon that absorb incident acoustic shock waves. For example, a layered baffle-stack of multiple perforated plates may be used as layered angled reflectors.

In addition, the walls of the laser chamber may be configured to assist in the dissipation of the acoustic shock waves through absorption, scattering, and by generating interference within the reflected waves. For example, the layered baffle stack may be used along the walls of the laser chamber to absorb and scatter incident waves. The walls of the laser chamber may also be covered with an acoustic shock-wave absorbing material, such as felt metal. Alternatively, the walls of the laser chamber may have grooves, such as triangular or rectangular grooves, which scatter incident waves and generate interference within the waves.

It is believed that none of the prior-art proposed methods provides adequate suppression of these acoustic shock waves generated by the high pulse-repetition frequency operation. Accordingly, there is a need for more effective acoustic shock-wave suppression scheme than has hitherto been proposed.

### SUMMARY OF THE INVENTION

The present invention is directed to damping gas-discharge-initiated acoustic disturbances in laser gas of an excimer or F₂ laser. In one aspect, the invention comprises an electrode assembly including first and second electrodes arranged face-to-face, leaving a gap therebetween. When electrical power is applied to the electrodes a gas discharge is struck in laser gas in the gap. At least one of the electrodes is partly covered by a ceramic foam for damping an acoustic disturbance in the laser gas that is initiated by the striking of the gas discharge.

In one experiment, refractive index variations in the laser gas resulting from firing a discharge pulse were measured, from the time of firing a discharge pulse, for a prior-art electrode arrangement in which neither electrode had a foam covering, and for the same arrangement in which only one electrode had a foam covering in accordance with the present invention. Even with only the one electrode covered by ceramic foam, refractive index variations were significantly reduced compared with those of the prior-art electrode arrangement.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIG. 1 is a lateral cross-section view that schematically illustrates a prior-art excimer laser including a laser chamber containing a laser gas, the laser chamber having an upper portion and a lower portion, the upper portion of the chamber including an electrode assembly having spaced apart upper and lower electrodes, each of the electrodes having a ridged portion extending from shoulder portions, a discharge occurring in a gap between the ridged portion when a voltage of applied across the electrodes, the upper portion of the chamber further including spoiler units laterally spaced apart from the lower electrodes for guiding gas flow between the electrodes, the lower portion of the chamber including an arrangement including a cylindrical fan for causing laser gas contained in the chamber to circulate and flow through the gap between the electrodes.

FIG. 1A is a three-dimensional cut-away view schematically illustrating further details of components of the laser of FIG. 1.

FIG. 2 is a lateral cross-section view that schematically illustrates an excimer laser in accordance with the present invention similar to the laser of FIG. 1 but including an arrangement for damping acoustic shock waves caused by the gas discharge, and an arrangement for optimizing gas flow between electrodes of the electrode assembly, the shock-wave damping arrangement including ceramic foam layers covering the shoulder portions of the electrodes, exposed surfaces of the spoilers, and inner exposed surfaces of the upper portion of the laser chamber, and the gas-flow-optimizing-assembly including a perforated plate arranged between a spoiler and the lower electrode transverse to the flow path of lasing gas directed into the discharge.

FIG. 3 schematically illustrates one preferred example of the perforated plate of the laser of FIG. 2 including a plurality of circular apertures extending therethrough for permitting gas flow through the plate.

FIG. 3A schematically illustrates another preferred example of the perforated plate of the laser of FIG. 2 having a plurality rectangular apertures extending therethrough for permitting gas flow through the plate.

FIG. 4 is a lateral cross-section view schematically illustrating yet another preferred embodiment of an excimer laser in accordance with the present invention, similar to the laser of FIG. 2, but further including ceramic foam plates covering spaces between the spoilers and the upper electrode for damping acoustic shock waves caused by the pre-ionizers and the main discharge.

FIG. 5 is a lateral cross-section view schematically illustrating still another preferred embodiment of an excimer laser in accordance with the present invention, similar to the laser of FIG. 2, but wherein the perforated plate is replaced by a pair of guide plates arranged spaced apart and generally aligned in the direction of desired gas flow for channeling gas from the fan into a space between the lower electrode and one of the spoilers.

FIG. 6 is a lateral cross-section view schematically illustrating still yet another preferred embodiment of an excimer laser in accordance with the present invention, similar to the laser of FIG. 4, but having a different electrode configuration.

FIG. 7 is a lateral cross-section view schematically illustrating a further preferred embodiment an excimer laser in accordance with the present invention, similar to the laser of FIG. 6, but further including the gas guide plates of the laser of FIG. 5.

FIG. 8 is a lateral cross-section view schematically illustrating another electrode configuration in accordance with the present invention.

FIG. 9 is a graph schematically representing relative change (disturbance) of the laser gas refractive index after initiation of a gas discharge in a prior-art laser, and in the same laser with one electrode having a layer of ceramic foam thereon in accordance with the present invention.

### DETAILED DESCRIPTION OF THE INVENTION

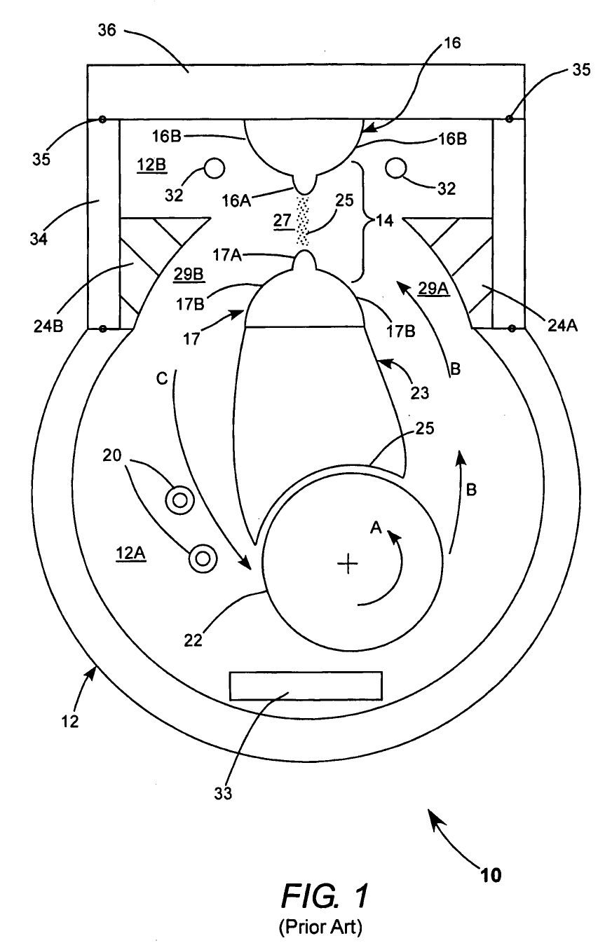

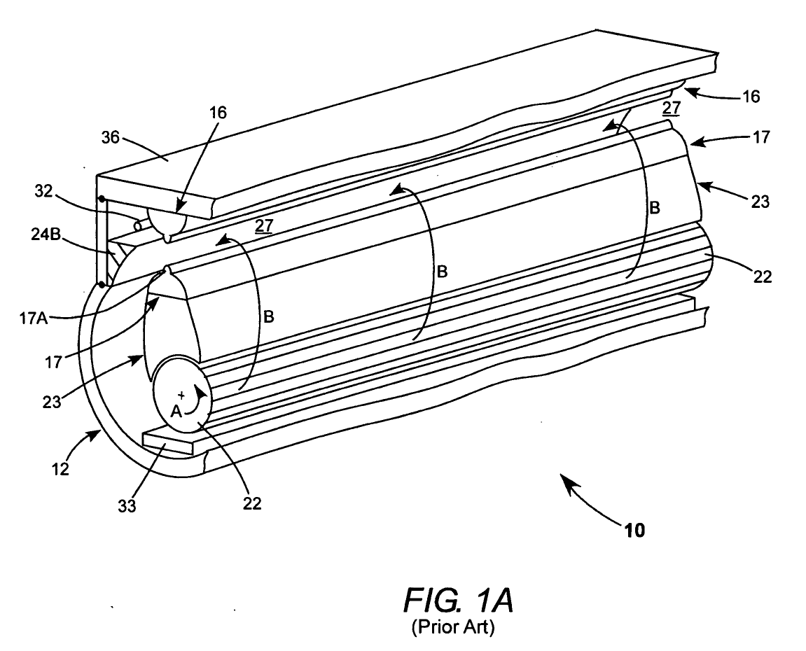

Referring now to the drawings, wherein like components are designated by like reference numerals, FIG. 1 is a lateral cross-section view schematically illustrating a prior-art excimer laser 10 including a laser chamber 12 having a lower portion 12A and an upper portion 12B. In this drawing, and in similar drawings herein, traditional cross-section shading has been omitted in certain features to avoid obscuring certain details. FIG. 1A is a three-dimensional cut-away view schematically depicting the longitudinal extent of selected components of laser 10. In this detailed description the term “excimer laser” should be understood to include a molecular F₂ laser.

An electrode assembly 14 is located in upper portion 12B of chamber 12. Electrode assembly 14 includes an elongated upper electrode 16 (cathode) and an elongated lower electrode 17 (anode). The upper electrode 16 is attached to a cathode plate 36. Cathode 16 has a central, conductive, ridge or nose portion 16A extending from shoulder portions 16B disposed on opposite sides thereof. Cathode 17 has a central conductive ridge portion 17A extending from shoulder portions 17B. In this example, the electrodes have a cross-section in which shoulder portions thereof are rounded. This prior-art laser configuration is described in detail in U.S. Pat. No. 6,546,036, assigned to the assignee of the present invention, and the complete disclosure of which is hereby incorporated herein by reference.

Electrodes 16 and 17 are separated by a gap or discharge area 27 through which a gas mixture is flowed, as indicated by arrow B. The cathode plate 36 and a ceramic frame 34 are sealed by an O-ring 35 and form an upper portion 12B of laser chamber 12. A second O-ring 35 seals the ceramic frame 34 to the laser chamber 12. Located below electrode 17 in the lower portion of the laser chamber is a gas flow guide 23. A fan 22 is located close to the gas flow guide, which has a cut-away section 25 to accommodate the fan. Rotation of the fan indicated by arrow A, and the form and positioning of the gas flow guide, causes the laser gas to flow toward and into a channel 29A between an elongated spoiler 24A and anode 17 as indicated by arrows B. The gas from channel 29A passes through gap 27, flows through another channel 29B between another spoiler 24B, then returns to the fan for recirculation as indicated by arrow C. Spoilers 24A and 24B are attached to the ceramic frame 34. A dust precipitator 33 is used to clean the laser gas mixture of dust particles.

When a high voltage pulse is applied across the electrode assembly 14, a discharge 25 occurs in gap 27 between conductive ridge portions 16A and 17A of cathode 16 and anode 17, respectively. Typically a discharge pulse is one of a series of discharges (pulses), repeatedly fired. By way of example, a discharge pulse may have a duration between about 3.9 and 100.0 nanoseconds (ns), and the discharge pulses may be repeated at a frequency between about 1.0 and 8.0 kilohertz (kHz). The gas mixture is naturally heated as it is excited by the electrical discharge in gap 27. Heat exchangers 20 cool the heated gas after the gas exits gap 27.

One, two, or more pre-ionization units 32 are located in upper chamber-portion 12B and are used to pre-ionize the laser gas in the gap 27 before discharge 25 is initiated. Such pre-ionization helps make initiation of discharge repeatable in response to the applied voltage, and provides for a faster rise-time of the discharge than would be the case without pre-ionization. Pre-ionization units may include ultraviolet light emitting tubes (represented here in cross-section) extending along the length of the laser chamber. Alternatively, pre-ionization may be accomplished by a plurality of pin electrodes extending through (and insulated from) cathode plate 36. As pre-ionization arrangements are well known in the gas laser art, no further description thereof is presented herein.

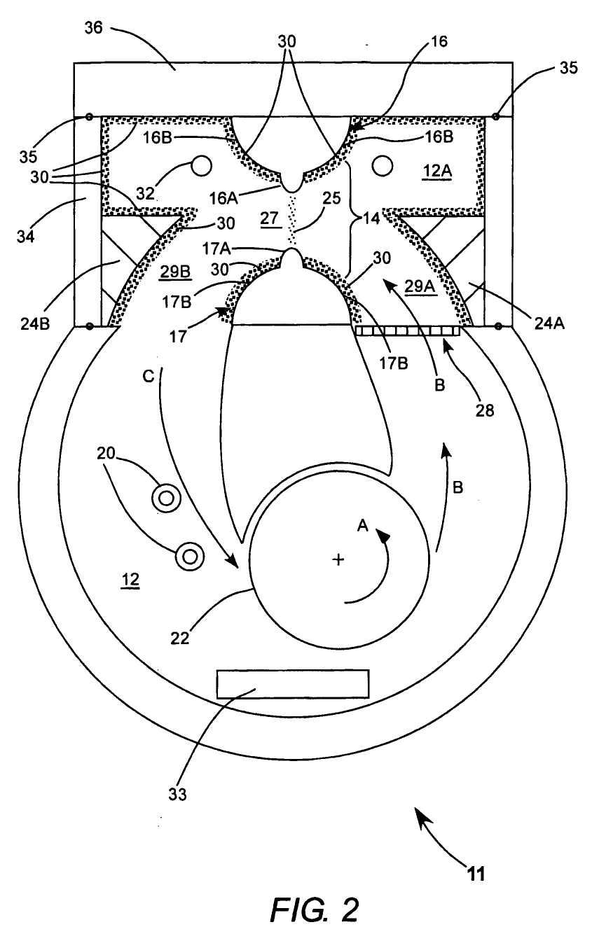

FIG. 2 is a lateral cross-section view schematically illustrating one preferred embodiment 11 of an excimer laser in accordance with the present invention. Laser 11 is similar to laser 10 of FIGS. 1 and 1A with an exception that measures for suppressing (damping) above-discussed acoustic shock waves caused by the pulsed gas discharge are provided. Here, the shock-wave damping measures include covering shoulder portions 16B and 17B of upper and lower electrodes 16 and 17 respectively with a layer of a ceramic foam material 30. Ridge portions 16A and 17A of the electrodes are left uncovered so that formation of discharge 25 is not impeded. In addition, exposed surfaces of spoilers 24A and 24B are covered with a layer of the foam material 30 as well as inner, exposed surfaces of upper portion 12A of laser chamber 12.

It should be noted, here, that it is not necessary to cover all of the surfaces discussed above with the ceramic foam material to achieve shock wave damping in accordance with the present invention. At a minimum, however, at least one electrode, preferably the high-voltage electrode, must have a portion thereof covered by the ceramic foam. Indeed, in one experimental arrangement, covering only shoulder portions of cathode 16 with a ceramic foam resulted in a significant reduction of acoustic disturbances compared with those present in a corresponding prior-art laser. This result discussed is in more detail further hereinbelow. While covering other surfaces with ceramic foam can provide additional damping, other damping measures, including above-discussed prior-art damping measures, may be applied to these other surfaces without departing from the spirit and scope of the present invention.

The ceramic foam material comprises a matrix of pores or voids and sintered ceramic material. The pores or voids have a random size distribution about some nominal average size. The material can be characterised as having a median number of pores or voids per linear inch. Preferably, the material is selected to have an average number of pores (voids) per inch between about 20 and 80. One preferred ceramic foam is commercially available from Fraunhofer Institut, Keramische Technologien und Sinterwerkstoffe, Dresden, Germany, as material PPI 20-80, the name PPI, here, referring to the above-discussed porosity in pores per inch (ppi). This preferred material is formed from alumina (Al₂O₃) having a purity of about 99.5%. Ceramic materials with a high fraction of silicon (Si), carbon (C), or phosphorus (P) are to be avoided in an excimer laser as these materials are incompatible with the laser gases. Preferably, any ceramic material used should have a content of Si, C, or P less than about 1%. In any ceramic foam material, there should be a minimum of closed pores or voids. Such closed pores or voids could trap gas that could eventually leak therefrom into the laser chamber, and thereby possibly, eventually contaminate laser gases in the chamber. Preferably, the content of closed pores should be less than about 0.1% of the total number of pores. The ceramic foam can be attached to an electrode body with metal screws or clamps or by integrated, solid ceramic elements.

Another possible ceramic material for ceramic foam is zirconia (ZrO₂). Zirconia ceramic foam material is commercially available from Drache-Umwelttechnik GmbH of Diez, Germany. In certain experiments a 60-ppi ZrO₂ foam provided adequate damping but unfortunately had poor compatibility with the laser gases. It was not possible to passivate the laser chamber properly. The gas lifetime was 4 times less then for a prior-art laser, and the energy per laser output pulse was ½ of the expected value. It was not possible, because of lack of available resources, to determine whether the ZrO₂ chemical composition, closed-pore content, purity of the material, or cleanliness of the material caused the observed problems.

In one method of manufacture, the ceramic foam is formed by first immersing polyester foam having a porosity about the same as the porosity of ceramic foam desired in a ceramic slurry, in a manner such that all surfaces of the polyester foam are covered with a thin layer of the slurry. The ceramic-covered polyester is then heated to a temperature sufficient to sinter the ceramic slurry. The polyester material, at this sintering temperature, is vaporized, leaving behind the sintered ceramic and voids forming the ceramic foam.

In ceramic foam manufactured in this manner, the average dimension of pores or voids is usually inversely proportional to the average pore-count in pores per inch. The relationship between porosity in ppi and the average pore size in millimeters (mm) can be approximated by the formula
ppi=1.6*25.4/Φₚₒᵣₑ, (1)
wherein Φₚₒᵣₑ is the average pore size in mm, 1.6 is a geometrical factor, and 25.4 is the numerical conversion factor required to reconcile the pore size specified in mm with the porosity per inch. Accordingly the above-discussed preferred range of porosity of between about 20 and 80 ppi transforms to a preferred range of average pore size between about 2.0 mm and 0.5 mm. One particularly preferred porosity is 60 ppi. A preferred thickness of a layer of the ceramic foam is about between about 1.0 mm and 10.0 mm. This provides adequate shock wave damping, consistent with adequate mechanical strength. Such a 60-ppi ceramic foam would have an average pore size of about 0.7 mm.

As the surface of the ceramic foam material is not smooth, laser gas flow through channel 29A and gap 27 can be adversely influenced depending on which surfaces are covered by the foam. The adverse influence may result, for example, from increased turbulence in the flowing gas or reduction of volume flow. This can reduce the maximum pulse repetition rate at which the laser can be operated.

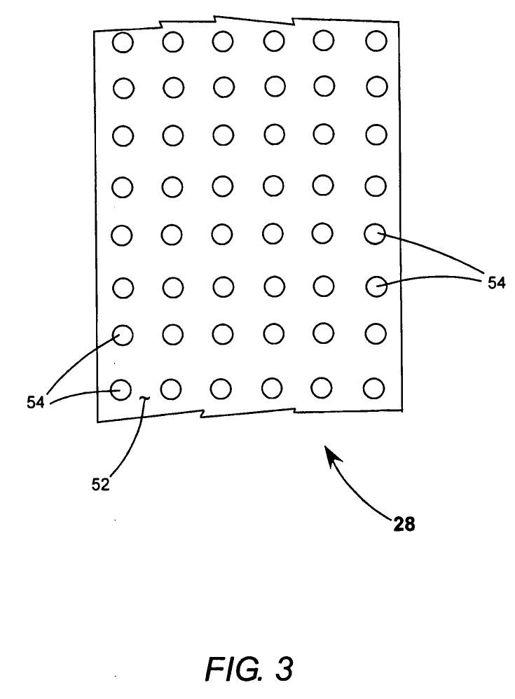

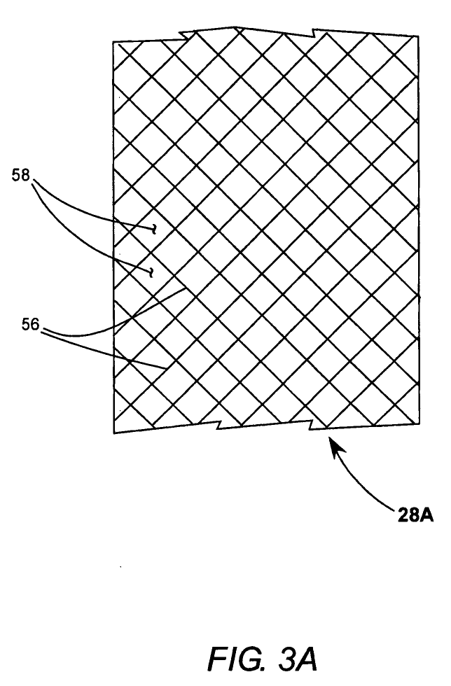

Continuing with reference to FIG. 2, one preferred arrangement for optimizing gas flow through gap 27 is to provide, in the entrance to channel 29A (from the point of view of the flowing gas) a plate 28, having apertures extending therethrough for permitting gas flow therethrough and extending along the length of electrode 17, and between electrode 17 and spoiler 24A. One preferred configuration of plate 28 is schematically depicted in FIG. 3. Here the plate is formed from a sheet 52 having a plurality of circular apertures 54 extending therethrough. Plate 28 is preferably made from a metal but may also be made from a ceramic. It should be noted that in FIG. 3 external dimensions of the plate are arbitrarily selected and serve only to illustrate the manner in which the plate is perforated. In practice the amount and dimensions of the perforations are preferably selected such that plate 28 is at least about 60% transmissive for gas impinging thereon. In one preferred such arrangement, sheet 52 has a thickness of about 1.5 millimeters (mm), apertures 54 have a diameter of about 2.5 mm, and the apertures are arranged and spaced apart to provide the preferred 60% or greater throughput for the flowing gas. The plate and apertures therein serve to reduce the turbulence in the gas that might result in the absence of such a plate. Another preferred arrangement of plate 28 is schematically illustrated in FIG. 3A. Here, the plate is in the form of a grid or grating having rib members 56 defining a plurality of diamond-shaped or rectangular apertures 58 extending through the grid. Those skilled in the art may devise other forms of aperture for a plate 28 without departing from the spirit and scope of the present invention.

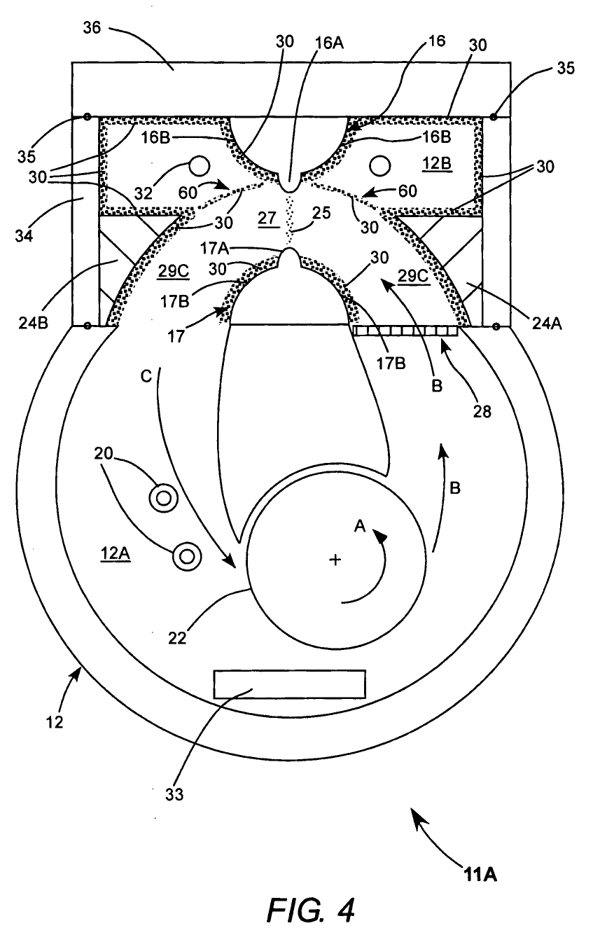

FIG. 4 schematically illustrates another preferred embodiment 11A of an excimer laser in accordance the present invention. This laser 11A is similar to laser 11 of FIG. 2 with an exception that a plate 60 of ceramic foam 30 is located between ridge portion 16A of electrode 16 and spoiler 24A, and a similar plate 60 is located between ridge portion 16A of electrode 16 and spoiler 24A. Plates 60 combine with channels 29A and 29B of laser 11, to provide a substantially continuous channel 29C extending through discharge gap 27 through which laser gas flows. Plates 60 are preferably curved to match the curvature of gas-flow-facing surfaces of spoilers 24A and 24B.

Pre-ionization units 32 produce acoustic shock waves in addition to those produced by discharge 25 between ridge portions 16A and 17A of electrodes 16 and 17. While the shock waves from the pre-ionization units are generally of lesser magnitude than the shock waves from the main discharge 25, it is nevertheless preferable to damp the pre-ionization shock waves in addition to damping the primary shock front coming from the main discharge. Such damping is achieved to some extent in laser 11 of FIG. 2 by the foam layers 30 on inner walls and spoiler surfaces of upper portion 12B of chamber 12. Without closing space between pre-ionizer units 32 and electrode 16, however, some portion of the pre-ionization shock waves could reach discharge gap 27. Ceramic foam plates 60 minimize, if not altogether prevent, this portion of the pre-ionizer shock wave from reaching discharge gap 27. It is important, however, that plates 60 be sufficiently thin, consistent with the porosity of the ceramic foam material 30, that pre-ionization created by pre-ionizing units 32 can penetrate through the plates into discharge gap 27. Were this not the case, the pre-ionizing units would not have the desired effect of encouraging repeatability or fast rise-time of the main discharge 25. By way of example, for ceramic foam material having a porosity of about sixty ppi (60 ppi), the thickness of plates 60 is preferably between about 3.0 and 5.0 mm.

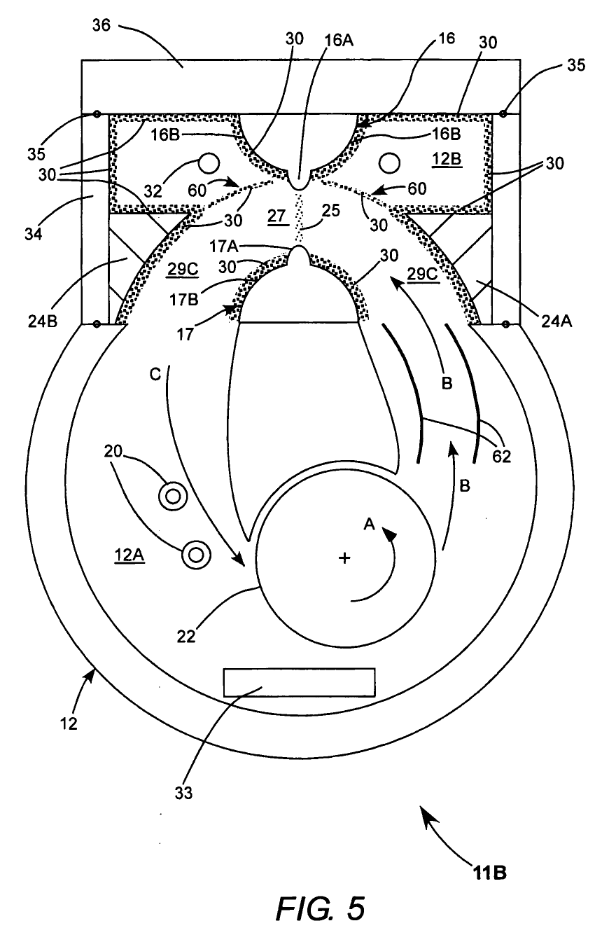

FIG. 5 schematically illustrates yet another embodiment 11B of an excimer laser in accordance with the present invention. Laser 11B is similar to above-discussed laser 11A of FIG. 4 with an exception that gas-flow-management plate 28 is replaced in laser 11B by a plurality (here two) of gas guide plates 62. Plates 60 are arranged face-to-face and spaced apart in lower chamber-portion 12A in a space between fan 22 and the entrance (from the point of view of gas flow) of channel 29C, with surfaces of the plates aligned in the direction of desired gas flow. The plates are preferably metal plates, curved in the width direction to provide a smooth passage of gas from the fan into the entrance of channel 29C, and preferably extend along the longitudinal extent of the channel.

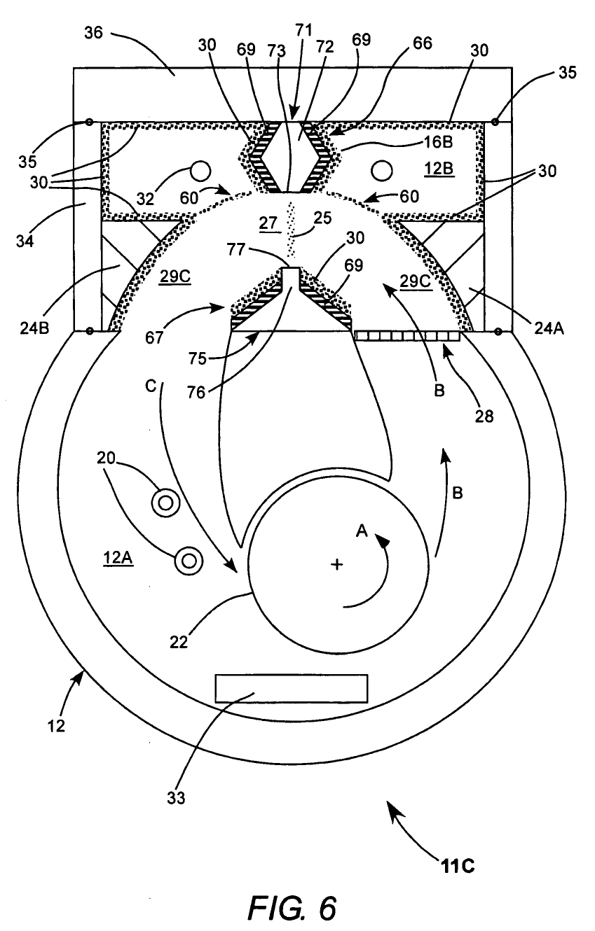

FIG. 6 schematically illustrates still another embodiment 11C of an excimer laser in accordance with the present invention. Laser 11C is similar to laser 11A of FIG. 4 with an exception that electrodes 16 and 17 of FIG. 4 are replaced in laser 11C by electrodes 66 (the cathode) and 67 (the anode) respectively. Cathode 66 has a body portion 71. Body portion 71 has a central core 72 having all but a conductive portion 73 thereof covered by a layer 69 of an insulating material. Insulating layer 69 of the electrode body is covered with a layer of ceramic foam 30. The ceramic foam is applied only to the insulating-layer so that the conductive portion 73 of the electrode body is left uncovered. Anode 67 has a body portion 75. Body portion 75 has a central core 76 having a cross-section that is generally triangular but having a conductive ridge portion extending therealong. All but a top portion 77 of conductive ridge portion 76 is covered by a layer 69 of an insulating material, with the insulating layer of the electrode body being covered with a layer of ceramic foam 30. Again, the ceramic foam is applied only to the insulating-layer so that the conductive portion 77 of the electrode body is left uncovered. Covering with an insulating material all but those portions of the electrodes between which it is desired to strike a gas discharge minimizes the possibility of sporadic arcs occurring between portions of the electrodes outside of the discharge region.

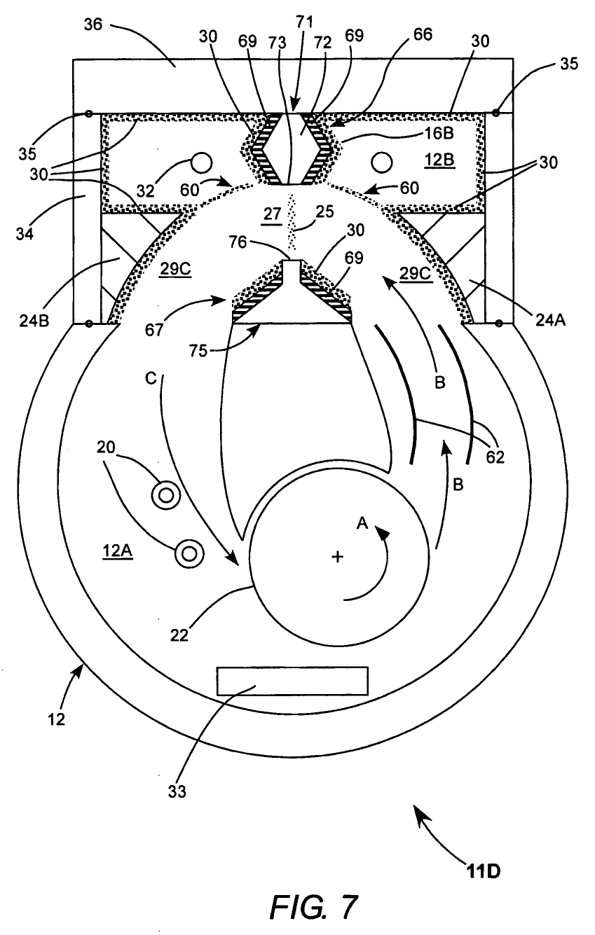

FIG. 7 schematically illustrates a further embodiment 11D of an excimer laser in accordance with the present invention. Laser 11D is similar to laser 11C of FIG. 6 with an exception that gas flow control plate 28 of laser 11C is replaced in laser 11D by baffle plates 62, described above with reference to laser 11B of FIG. 5.

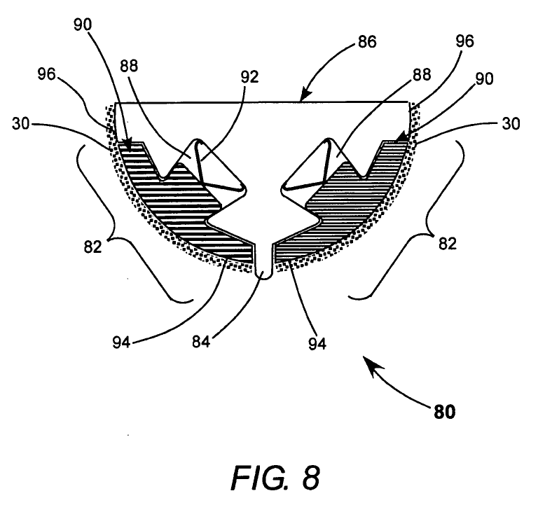

Another electrode configuration 80 in accordance with the present invention capable of minimizing arcing between electrodes is schematically depicted in FIG. 8. This configuration can be used for both the anode and cathode in any of the above-described embodiments of the inventive excimer laser. The electrode 80 includes rounded shoulder portions 82 with a ridge or nose portion 84 therebetween and extending outwardly therefrom. The ridge portion, here is a part of a solid conductive body 86 having two reverse-tapered slots 88, one thereof on either side of the ridge portion. A ceramic insert 90 is slotted into each of the slots. Each insert 90 is retained in the slot by a spring 92. The curvature of outer surface 94 of each insert 90, and outer surfaces 96 of the electrode body on both sides of the ridge portion thereof, are matched to provide the general curvature of the electrode body. A detailed description of such a composite electrode is provided in U.S. Patent Application No. 2004/0131100, assigned to the assignee of the present invention, and the complete disclosure of which is hereby incorporated herein by reference.

In electrode 80 the ceramic inserts act as an insulating barrier over the electrode body for minimizing arcing, similar to the insulating (ceramic) layers 69 of electrodes 66 and 67 in the lasers of FIG. 6 and FIG. 7. Similarly in electrode 80, shoulder portions 82 of the electrode, including the ceramic inserts 90 on either side of the ridge portion, are covered by a layer of shock-wave damping ceramic foam 30 as described above, while leaving conductive ridge portion 84 exposed. The ceramic insert can cover any appropriate amount of shoulder portions 82, for example between about 20% and 99%. If less than about 99% of the shoulder region is covered by an insert, the portion containing the insert can be positioned relative to the shoulder at a position that will most reduce the probability of arcing.

In above-discussed embodiments of the present invention, electrodes are depicted, for convenience of illustration, as being un-cooled, and having solid, conductive, body portions. While such a configuration will be adequate for many conditions of operation of an excimer laser, under some conductions, for example at high pulse repetition rates, it may be found advantageous to cool the electrodes. Cooling can be effected, for example, by providing tubes or channels with an electrode body and passing a cooling fluid through the tubes or channels. One skilled in the art may substitute a cooled electrode body for an un-cooled electrode body depicted herein, or substitute an electrode body having more than one component for any “one-piece” electrode body depicted herein without departing from the spirit and scope of the present invention.

As noted above the acoustic disturbances, to the damping of which this invention is directed, are unwanted pressure changes in the lasing gas. At the instant of igniting a discharge between the electrodes there is a rapid heating and expansion of the gas in the discharge. This causes an acoustic disturbance (shock front) to propagate outward from the discharge area. This disturbance is reflected from chamber walls and other components, including the electrodes themselves, absent any measures to prevent such reflection.

Reflected portions of the disturbance (shock fronts) return into the discharge area, through which the laser beam being generated by the discharge is propagating. The reflected shock fronts interfere with each other, causing a complex and rapidly changing distribution of pressure in the discharge area. The changes and distribution of pressure cause corresponding changes or disturbances in the refractive index of the laser gas, and the refractive index changes affect, among other parameters, the pointing or propagation direction of the laser beam. In an experiment to measure the effectiveness of the ceramic foam for damping acoustic disturbances, an effect representing variation of beam pointing of an excimer laser as a function of time was measured for a laser with and without the inventive shock-front damping.

In the experiment, the discharge chamber of the laser being evaluated was located at a distance of about 0.1 meters from an aperture, behind which was located a photodiode detector. The beam of a red pilot-laser was passed through the gap between the electrodes to provide a refractive index diagnostic laser beam. The diagnostic laser beam was directed through the chamber between the electrodes and was incident on the aperture. Because of the relative dimensions of the beam and the aperture, any change in beam pointing due to a change in the gas refractive index was manifest in a change in the signal from the photodiode in response to the incident beam. This change was used to provide a measure of the effectiveness of the ceramic foam in damping acoustic disturbances, i.e., gas refractive index disturbances.

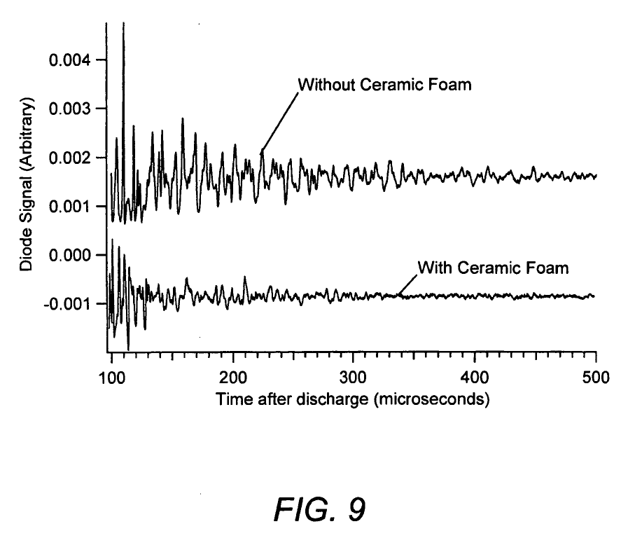

One result of the experiment is presented in FIG. 9, which is a graph illustrating the relative change of the gas refractive index variation signal as a function of time after firing a discharge pulse (striking a discharge) in a prior-art laser (upper trace) and in the same laser in which only the cathode (electrode 16 in FIG. 1) was modified in accordance with the present invention by applying a layer of alumina ceramic foam to shoulder portions thereof (upper trace). It should be noted that in the graph of FIG. 9, the lower trace is vertically offset to more clearly depict, on a single graph, the difference between the traces. In practice, the average signal in each trace is about the same.

The laser tested was a Lambda Physik® Model A4003 laser wherein the (uncovered) electrode configuration is similar to that of the electrodes of laser 10 of FIG. 1. In the modified configuration of that laser, the ceramic foam applied to the cathode of the laser had a porosity of 60 ppi with an average pore size of about 0.7 mm. The ceramic foam had a thickness of between about 3.0 and 5.0 mm.

It can be seen that even with only this minimum application of the ceramic foam to only one electrode, stability of the beam pointing at about 130 microseconds after the firing of the discharge pulse was dramatically improved. In numerical terms, between 130 and 300 microseconds (μs) the standard deviation of the upper trace is about 2.7 times greater than that of the lower trace. Equally, if not more important, is the fact that the range of disturbance is reduced more rapidly in the inventive arrangement. In the prior-art arrangement there is still significant disturbance in the gas after 250 μs. In a laser operating at 4 kHz, this is the time at which another discharge pulse would be fired. In the inventive arrangement, the range disturbance after 150 μs (about 6 kHz) has been reduced to less than that in the prior-art arrangement after 250 μs. Accordingly, the inventive arrangement should be capable of providing more stable laser operation at the same PRF as the prior-art arrangement, and the same stability of operation at a higher PRF than is possible in the prior-art arrangement.

In summary, the present invention is described above in terms of a preferred and other embodiments. The invention is not limited, however, to the embodiments described and depicted. Rather the invention is limited only by the claims appended hereto.

What is claimed is:

1. A gas laser, comprising:
an electrode assembly including first and second electrodes arranged face-to-face, leaving a gap therebetween such that when electrical power is applied to said electrodes and laser gas flows in said gap, a gas discharge is struck in said gap; and
wherein at least one of said electrodes is partly covered by a ceramic foam for damping an acoustic disturbance in said laser gas initiated by said striking of said gas discharge.

2. The laser of claim 1, wherein said ceramic foam has a porosity of between about 20 and 80 pores per inch (ppi).

3. The laser of claim 2, wherein said porosity is about 60 ppi.

4. The laser of claim 1, wherein said ceramic foam has an average pore size between about 0.5 mm and 2.0 mm.

5. The laser of claim 4, wherein the average pore size of said ceramic foam is about 0.7 mm.

6. The laser of claim 1, wherein said ceramic foam has a thickness of between about 1.0 mm and 10.0 mm.

7. The laser of claim 6, wherein said ceramic foam has a thickness between about 3.0 mm and 5.0 mm.

8. The laser of claim 7, wherein said ceramic foam is one of an alumina foam and a zirconia foam.

9. The laser of claim 8, wherein said ceramic foam is an alumina foam having a purity of about 99.5%.

10. The laser of claim 1, wherein said at least one electrode has a solid ceramic material beneath said partial covering of said ceramic foam.

11. The laser of claim 10, wherein said at least one electrode has a body including an electrically conductive material and said solid ceramic is in the form of a layer on said conductive material.

12. The laser of claim 10, wherein said at least one electrode has a conductive body with insulating inserts and said solid ceramic material forms one of said inserts.

13. The laser of claim 1, wherein both of said electrodes are partly covered by said ceramic foam and said gas discharge gap is between conductive portions of said electrodes not covered by said ceramic foam.

14. The laser of claim 1, wherein said at least one electrode has an electrode body including two shoulder portions flanking a protruding conductive ridge portion and said ceramic foam material covers said shoulder portions leaving the ridge portion uncovered.

15. The laser of claim 1, wherein said electrodes each have an electrode body including two shoulder portions flanking a protruding conductive ridge portion and in each electrode said ceramic foam material covers said shoulder portions leaving said ridge portion uncovered, said discharge gap is between said conductive ridge portions.

16. The laser of claim 1, further including an arrangement for causing said laser gas to flow toward said gap and a gas-transmissive baffle plate arranged transverse to the direction of flow of said gas for minimizing turbulence in said flowing gas.

17. The laser of claim 1, further including an arrangement for causing said laser gas to flow toward said gap and a plurality of baffle plates arranged spaced apart and aligned with the direction of flow of said gas for minimizing turbulence in said flowing gas.

18. The laser of claim 1, wherein said electrodes are located in a laser discharge chamber and at least one inner surface of said laser discharge chamber has a layer of ceramic foam thereon.

19. A gas laser, comprising:
a laser chamber having an upper portion and a lower portion and containing a laser gas;
an electrode assembly located in said upper chamber-portion, said electrode assembly including first and second elongated electrodes arranged face-to-face, leaving a discharge gap therebetween;
a fan located in said lower portion of said laser chamber said lower chamber-portion and said fan being arranged to cause said laser gas to flow from said lower chamber-portion to said upper chamber portion and through said gap and back to said lower chamber-portion;
an arrangement for applying an electrical pulse across said electrodes, thereby striking a gas discharge in said laser gas in said discharge gap;
wherein at least one of said electrodes is partly covered by a ceramic foam for damping an acoustic disturbance in said laser gas initiated by said striking of said gas discharge.

20. The laser of claim 19, further including a gas-transmissive baffle plate arranged between said upper and lower chamber-portions transverse to the direction of flow of said laser gas for minimizing turbulence in said flowing laser gas.

21. The laser of claim 19, further including a plurality of baffle plates located in said lower chamber portion and arranged spaced apart and aligned with the direction of flow of said gas for minimizing turbulence in said flowing gas.

22. The laser of claim 19, wherein at least one surface of said upper chamber-portion has a layer of said ceramic foam thereon.

23. The laser of claim 19, further including a pre-ionizing arrangement located in said upper chamber-portion, spaced apart from said electrode assembly, for ionizing said laser gas, and wherein there is a plate of said ceramic foam disposed between said pre-ionizing arrangement and said discharge gap between said electrodes.
